(19) United States
(12) Patent Application Publication
(10) Pub. No.: US 2011/0056354 A1
(43) Pub. Date: Mar. 10, 2011

(54) CUTTING FRAME OF HIGH CUTTING EFFICIENCY

(75) Inventors: Hokyung Lee, Daejeon (KR); Soonki Heo, Daejeon (KR); Jaein Choi, Daejeon (KR)

(73) Assignee: LG Chem, Ltd., Seoul (KR)

(21) Appl. No.: 12/677,079

(22) PCT Filed: Aug. 27, 2008
(86) PCT No.: PCT/KR08/05002

§ 371 Date: Oct. 22, 2010

(30) Foreign Application Priority Data
Sep. 8, 2007 (KR) 10-2007-0091264

(51) Int. Cl. B26F 3/00; B26F 1/44; B23K 26/00

(52) U.S. Cl. 83/177; 83/613; 219/121.6

(57) ABSTRACT

Disclosed herein is a cutter frame including a plurality of cutters for cutting one or more kinds of rectangular unit pieces having a relatively small size from a rectangular base material at a predetermined inclination, the cutters being mounted or formed in the cutter frame such that the cutters correspond to the rectangular unit pieces, two of the rectangular unit pieces being arranged mainly in the inclination direction such that the rectangular unit pieces are in contact with each other at one side of each rectangular unit piece, wherein, on the assumption that imaginary vertex coordinates of a leftmost end are (Ax, Ay), and imaginary vertex coordinates of a rightmost end are (Bx, By), when the rectangular unit pieces coincide with each other at a left or right side of each rectangular unit piece, vertex coordinates (B′x, B′y) of the rightmost end are greater than the imaginary vertex coordinates (Bx, By) of the rightmost end based on the imaginary vertex coordinates (Ax, Ay) of the leftmost end in an array having a higher cutting area ratio than the imaginary array.

### FIELD OF THE INVENTION

The present invention relates to a cutter frame of high cutting efficiency, and, more particularly, to a cutter frame including a plurality of cutters for cutting one or more kinds of rectangular unit pieces having a relatively small size from a rectangular base material at a predetermined inclination, the cutters being mounted or formed in the cutter frame such that the cutters correspond to the rectangular unit pieces, two of the rectangular unit pieces being arranged mainly in the inclination direction such that the rectangular unit pieces are in contact with each other at one side of each rectangular unit piece, wherein, on the assumption that imaginary vertex coordinates of a leftmost end are (Ax, Ay), and imaginary vertex coordinates of a rightmost end are (Bx, By), when the rectangular unit pieces coincide with each other at a left or right side of each rectangular unit piece, vertex coordinates (B′x, B′y) of the rightmost end are greater than the imaginary vertex coordinates (Bx, By) of the rightmost end based on the imaginary vertex coordinates (Ax, Ay) of the leftmost end in an array having a higher cutting area ratio than the imaginary array.

### BACKGROUND OF THE INVENTION

A technology for cutting a rectangular base material having a relatively large size to manufacture a plurality of rectangular unit pieces having relatively small sizes has been adopted in various fields. For example, a base material sheet having a predetermined width and a long length is repeatedly cut by a cutter frame to simultaneously manufacture a plurality of rectangular unit pieces though a one-time cutting process.

Meanwhile, the size (width) of the base material is specified, whereas the size of the rectangular unit pieces may vary as needed, due to various factors, such as the limitation of base material suppliers, the efficiency aspect of the manufacturing process, the fluctuation in demand of rectangular unit pieces, etc. In this case, the cutting efficiency greatly varies depending upon in which structure the cutter frame is constructed, i.e., in which structure cutters for cutting the rectangular unit pieces from the base material are arranged, when cutting a plurality of desired rectangular unit pieces based on the size of the base material. The low cutting efficiency increases the amount of scrap, produced from the base material, which will be disposed of after the cutting process, with the result that eventually, the manufacturing costs of the rectangular unit pieces increase.

When the size (width and length) of a base material is in constant proportion to the size (lateral length and longitudinal length) of specific rectangular unit pieces, it is possible to minimize the cutting loss by sequentially arranging the rectangular unit pieces such that the rectangular unit pieces are brought into contact with one another at positions having such constant proportion. However, when such constant proportion is not formed, the cutting loss may vary depending upon the array structure of the rectangular unit pieces.

Furthermore, when the rectangular unit pieces are to be cut at a predetermined angle to the longitudinal direction of the base material, a large amount of scrap is inevitably produced.

In order to cut the rectangular unit pieces at the predetermined angle, there is generally used an array structure in which cutters (for example, knives) are arranged in the cutter frame such that the rectangular unit pieces corresponding to the cutters are adjacent to one another.

In connection with this matter, FIGS. 1 and 2 typically illustrate a conventional cutter frame in which rectangular unit pieces are located on a base material to construct cutters corresponding to the rectangular unit pieces. For convenience of description, the base material is illustrated to have a predetermined length.

Referring to these drawings, a plurality of desired rectangular unit pieces 20 are cut from a base material sheet 10 having a predetermined width and a long length. In a cutter frame 30 are arranged a plurality of cutters 32 corresponding to the rectangular unit pieces 20. Consequently, the array structure of the rectangular unit pieces 20 is substantially identical to that of the cutters 32.

The cutters 32 are mounted or formed in the cutter frame 30 such that the cutters 32 can cut a predetermined number (six in FIG. 1 and eight in FIG. 2) of the rectangular unit pieces 20 through a one-time cutting process. Consequently, the base material sheet 10 is cut by the cutter frame 30, and then the base material sheet 10 is cut again by the cutter frame 30 while the base material sheet 10 is overlapped by a predetermined length s in the longitudinal direction of the base material sheet 10. In this way, a series of cutting processes are carried out.

Each rectangular unit piece 20 is constructed in a rectangular structure in which a longitudinal side a of each rectangular unit piece 20 is longer than a lateral side b of each rectangular unit piece 20. Also, each rectangular unit piece 20 is inclined at an angle α of approximately 45 degrees to the longitudinal direction of the base material sheet 10. When the inclined rectangular unit pieces 20 are arranged on the base material sheet 10, it is possible to generally consider two array structures of the rectangular unit pieces as shown in FIGS. 1 and 2.

The first array structure of the rectangular unit pieces is to sequentially arrange the rectangular unit pieces such that the lateral sides b of the respective rectangular unit pieces coincide with one another, as shown in FIG. 1. According to this array structure, it is possible to cut a total of 24 rectangular unit pieces 20 from a base material sheet 10 having an effective width W and length L. However, it is not possible to cut a rectangular unit piece 21 located at a position deviating from the effective width W of the base material sheet 10.

In this array structure, only a cutting width D, not the effective width W, of the base material sheet 10 is substantially used, and therefore, the remaining width W-D is disposed of as scrap. Since the rectangular unit pieces 20 are inclined at an angle of approximately 45 degrees, scrap is also inevitably produced at the upper end region of the base material sheet 10.

The second array structure of the rectangular unit pieces is to sequentially arrange the rectangular unit pieces such that the longitudinal sides a of the respective rectangular unit pieces coincide with one another, as shown in FIG. 2. According to this array structure, it is possible to cut a total of 19 rectangular unit pieces 20 from a base material sheet 10 having an effective width W and length L.

In consideration of the above description, it can be seen that the cutting efficiency may vary according to the array structure of the rectangular unit pieces. However, when the rectangular unit pieces are inclined at a specific angle to the base material sheet, it is not easy to arrange the rectangular unit pieces in various array structures. For this reason, only the array structure of the rectangular unit pieces in which specific sides (longitudinal sides or lateral sides) of the respective rectangular unit pieces coincided with one another as shown in FIG. 1 or 2 is mainly considered in the conventional art.

Furthermore, when two or more kinds of rectangular unit pieces having different sizes are to be cut from the same base material, the array structure of the rectangular unit pieces is very complicated. For this reason, consideration is given to only the array structure of the rectangular unit pieces in which specific sides of the respective rectangular unit pieces coincide with one another or central axes of the respective rectangular unit pieces coincide with one another.

Consequently, when an array structure of the rectangular unit pieces exhibiting higher cutting efficiency than that of the array structures of the rectangular unit pieces as described above, it is possible to lower the cutting loss and eventually reduce the manufacturing costs of products. The improvement of the cutting efficiency is more and more serious especially when the price of the base material is high and/or the rectangular unit pieces are to be manufactured on a large scale.

### SUMMARY OF THE INVENTION

Therefore, the present invention has been made to solve the above problems, and other technical problems that have yet to be resolved.

As a result of a variety of extensive and intensive studies and experiments on a cutter frame, the inventors of the present invention have found that, when cutters are formed in a specific array structure of rectangular unit pieces, which will be hereinafter described in detail, such that the cutters correspond to the respective rectangular unit pieces, the cutting efficiency is greatly improved as compared with the conventional array structure of the rectangular unit pieces. The present invention has been completed based on these findings.

Specifically, it is an object of the present invention to provide a cutter frame including cutters formed to exhibit high cutting efficiency when cutting a plurality of rectangular unit pieces inclined at a predetermined angle to the longitudinal direction of a rectangular base material having a relatively large size from the rectangular base material.

It is another object of the present invention to provide a scrap having bores corresponding to the rectangular unit pieces arranged in the array structure of the rectangular unit pieces exhibiting the high cutting efficiency as described above.

In accordance with one aspect of the present invention, the above and other objects can be accomplished by the provision of a cutter frame including a plurality of cutters for cutting one or more kinds of rectangular unit pieces having a relatively small size from a rectangular base material at a predetermined inclination, the cutters being mounted or formed in the cutter frame such that the cutters correspond to the rectangular unit pieces, two of the rectangular unit pieces being arranged mainly in the inclination direction such that the rectangular unit pieces are in contact with each other at one side of each rectangular unit piece, wherein, on the assumption that imaginary vertex coordinates of a leftmost end are (Ax, Ay), and imaginary vertex coordinates of a rightmost end are (Bx, By), when the rectangular unit pieces coincide with each other at a left or right side of each rectangular unit piece, vertex coordinates (B′x, B′y) of the rightmost end are greater than the imaginary vertex coordinates (Bx, By) of the rightmost end based on the imaginary vertex coordinates (Ax, Ay) of the leftmost end in an array having a higher cutting area ratio than the imaginary array. According to circumstances, this array structure of the rectangular unit pieces may be referred hereinafter to as a ‘first invention.’

In accordance with another aspect of the present invention, there is provided a cutter frame including a plurality of cutters for cutting one or more kinds of rectangular unit pieces having a relatively small size from a rectangular base material at a predetermined inclination, the cutters being mounted or formed in the cutter frame such that the cutters correspond to the rectangular unit pieces, two of the rectangular unit pieces being arranged in the direction mainly perpendicular to the inclination direction such that the rectangular unit pieces are in contact with each other at one side of each rectangular unit piece, wherein, on the assumption that imaginary vertex coordinates of a leftmost end are (Cx, Cy), and imaginary vertex coordinates of a rightmost end are (Dx, Dy), when the rectangular unit pieces coincide with each other at a left or right side of each rectangular unit piece, vertex coordinates (D′x, D′y) of the rightmost end have D′x less than Dx and D′y greater than Dy in an array having a higher cutting area ratio than the imaginary array. According to circumstances, this array structure of the rectangular unit pieces may be referred hereinafter to as a ‘second invention.’

When the rectangular unit pieces are cut from the rectangular base material at the predetermined inclination, as previously described, the utilization of the base material in the lateral direction thereof is the most important. Accordingly, when the position coordinates of the rectangular unit pieces are specifically configured according to the present invention, unlike the conventional art in which the rectangular unit pieces fully coincide with one another at one side of each rectangular unit piece as shown in FIGS. 1 and 2, the rectangular unit pieces are in an array structure in which one side of one rectangular unit piece does not completely coincide with, but is somewhat offset from, the corresponding side of another rectangular unit piece, although the rectangular unit pieces are arranged such that the rectangular unit pieces are in contact with one another. It was confirmed that this unique array structure of the rectangular unit pieces maximizes the utilization of the base material in the lateral direction thereof, thereby providing higher cutting efficiency than the conventional cutter frame to our surprise.

Also, their ultimate purposes are the same in that the utilization of the base material in the lateral direction thereof is maximized, but it was confirmed that the cutting efficiency is improved by increasing the number of the rectangular unit pieces arranged in the lateral direction of the base material in the direction in which the rectangular unit pieces are arranged such that the rectangular unit pieces are in contact with one another at one side of each rectangular unit piece or decreasing the width of the array of the rectangular unit pieces in the longitudinal direction of the base material when the numbers of the rectangular unit pieces are the same. That is, the method of increasing the number of the rectangular unit pieces in the lateral direction of the base material corresponds to the first invention, and the method of decreasing the width of the array of the rectangular unit pieces in the longitudinal direction of the base material corresponds to the second invention.

When a plurality of the rectangular unit pieces are repeatedly arranged in the above-described array structure of the rectangular unit pieces, it is possible to greatly reduce the cutting loss and greatly improve the cutting efficiency as compared with the conventional art.

The cutter frame according to the present invention is preferably used to cut the rectangular unit pieces while the rectangular unit pieces are inclined at a predetermined angle. The inventors of the present invention have confirmed that, when the respective unit pieces are constructed in a square structure or the rectangular unit pieces are cut while not being inclined, high cutting efficiency is exhibited by an array structure in which the unit pieces are arranged adjacent to one another such that the opposite sides of the unit pieces fully coincide with one another, but, when the rectangular unit pieces are cut while the rectangular unit pieces are inclined at a predetermined angle, the cutting efficiency is further improved by establishing position coordinates of the rectangular unit pieces such that a series of the rectangular unit pieces are offset from one another. This is an epoch-making discovery to overthrow the conventional concept in that the cutting efficiency is exhibited only when a series of the rectangular unit pieces are arranged such that the rectangular unit pieces coincide with one another at one side of each rectangular unit piece or when the rectangular unit pieces are arranged such that the rectangular unit pieces are located on the same axis.

In the above description, when the rectangular unit pieces are in contact with one another at one side of each rectangular unit piece mainly in the inclination direction or in the direction mainly perpendicular to the inclination direction, the term ‘mainly’ means the direction in which a ratio of the length of the contact region to the total length of the contact side is relatively large in relations between the neighboring rectangular unit pieces. In connection with this matter, the neighboring rectangular unit pieces are in full contact with one another at the short side of each rectangular unit piece and in partial contact with one another at the long side of each rectangular unit piece in the array structure of the rectangular unit pieces shown in FIG. 1. Consequently, it may be defined that the rectangular unit pieces are arranged such that the rectangular unit pieces are in contact with one another at one side of each rectangular unit piece mainly in the inclination direction. On the other hand, the array structure of the rectangular unit pieces shown in FIG. 2 may be defined to be the structure in which the rectangular unit pieces are arranged such that the rectangular unit pieces are in contact with one another at one side of each rectangular unit piece in the direction mainly perpendicular to the inclination direction.

According to the present invention, it is required for two rectangular unit pieces arranged such that the rectangular unit pieces are in contact with each other at one side of each rectangular unit piece to be arranged such that the rectangular unit pieces are in contact with each other at one side of each rectangular unit piece in the inclination direction or in the direction mainly perpendicular to the inclination direction, as defined above. Consequently, it is required to adjust the difference between the vertex coordinates of the rightmost end and the imaginary vertex coordinates of the rightmost end within a range to maintain such contact.

When considering this requirement, the contact is not maintained at coordinates (Ex, Ey) on an extension line of the diagonal axis of the left rectangular unit piece in the first invention. Consequently, it is preferred that the vertex coordinates (B′x, B′y) of the rightmost end not be the coordinates (Ex, Ey), which will be described in detail hereinafter with reference to FIG. 4.

Also, in the second invention, it is preferred that the vertex coordinates (D′x, D′y) of the rightmost end not be vertex coordinates (Fx, Fy) of the rightmost end when the vertex coordinates of the uppermost end are located on an extension line of the diagonal axis of the rectangular unit piece, which will be described in detail hereinafter with reference to FIG. 8.

All the rectangular unit pieces are arranged while being inclined at a predetermined angle to the longitudinal direction of the base material. This arrangement is required when inherent physical properties of the base material in the longitudinal direction or in the lateral direction must be expressed by a predetermined angle with respect to the rectangular unit pieces. For example, the rectangular unit pieces may be inclined at an angle of 20 to 70 degrees, preferably 45 degrees.

In a preferred embodiment, the base material is a film including layers (‘absorption layers or transmission layers’) that absorb or transmit only a specific-direction wave motion of light or an electromagnetic wave in the longitudinal direction or in the lateral direction, and the rectangular unit pieces cut from the base material is a relatively small-sized film of which the absorption layers or the transmission layers are inclined at an angle of 45 degrees.

When the rectangular unit pieces are arranged such that the rectangular unit pieces have predetermined coordinates relations according to the present invention, the cutters may be arranged such that an axis (‘actual center connection axis’) to interconnect central points of the two rectangular unit pieces has an angle deviation (δ) of 0<δ<90 from an axis (‘imaginary center connection axis’) to interconnect central points of the two rectangular unit pieces when one of the two rectangular unit pieces, arranged in the inclination direction such that the rectangular unit pieces are in contact with each other at one side of each rectangular unit piece, coincides with the other rectangular unit piece at a left or right side of each rectangular unit piece.

When the two rectangular unit pieces have the same size, the imaginary center connection axis may be parallel or perpendicular to the inclination axis. That is, when the two rectangular unit pieces are in contact with one another at one side of each rectangular unit piece mainly in the inclination direction, the imaginary center connection axis is parallel to the inclination axis. On the other hand, when the two rectangular unit pieces are in contact with one another at one side of each rectangular unit piece in the direction mainly perpendicular to the inclination direction, the imaginary center connection axis is perpendicular to the inclination axis.

When the rectangular unit pieces have a cutting inclination angle of A, it is preferred that the angle deviation (δ) of the center connection axis from the inclination axis satisfy a condition of 0<δ<A.

The angle deviation may vary depending upon the width of the base material or the sizes of the rectangular unit pieces. Preferably, it is possible to maximize the cutting efficiency by arranging the maximum number of the rectangular unit pieces, or minimizing the width of the array, while the rectangular unit pieces are arranged at a predetermined inclination to the width of the base material.

In a preferred embodiment, when the cutting inclination angle is 45 degrees, the angle deviation (δ) has a range of 0<δ<20.

In this array structure of the rectangular unit pieces, the rectangular unit pieces are somewhat offset from one another such that one rectangular unit piece is in contact with only another rectangular unit piece at each side thereof. When this array structure of the rectangular unit pieces is applied to a plurality of the array structure of the rectangular unit pieces, a unique array structure of the rectangular unit pieces which can be expected in the conventional art is exhibited.

In the present invention, the base material may be a separate single material on which one-time or several-time cutting processes can be carried out or a continuous material having a predetermined width and a relatively very long length. The latter may be a long base material sheet. In this case, the base material sheet may be unwound from a roller, and the unwound base material sheet is sequentially cut by the cutter frame. In consideration of the manufacturing production efficiency and economical efficiency of the rectangular unit pieces, the base material is preferably a continuous material.

In the present invention, the array structure of the rectangular unit pieces substantially coincide with the cutters of the cutter frame or the array structure of the cutters. Consequently, it is interpreted that the array structure of the rectangular unit pieces means the cutters or the array structure of the cutters, so long as an additional description is not given.

The kind of the cutters is not particularly restricted so long as the cutters exhibit the structure or properties to cut the rectangular unit pieces from the base material. Typically, each of the cutters may be a knife for cutting, such as a metal knife or a jet water knife, or a light source for cutting, such as laser.

Meanwhile, two neighboring rectangular unit pieces are arranged such that the rectangular unit pieces fully coincide with each other at one side of each rectangular unit piece in the conventional art previously described with reference to FIGS. 1 and 2, with the result that, as long as the cutting width D and the effective width W of the base material are not in direct proportion, the cutting width D is greatly less than the effective width W. Consequently, the lower end region of the effective width W excluding the cutting width D is disposed of as scrap, and therefore, the manufacturing costs increases and the productivity decreases.

On the other hand, the cutter frame constructed in a structure in which the vertex coordinates of the rightmost end are shifted to a specific range according to the present invention has an array structure of the rectangular unit pieces to substantially increase the cutting area ratio of the base material as compared with the conventional art, which will be described in detail hereinafter.

First, it is assumed that the constant proportion is not formed, as previously described, and therefore, the effective width of the base material is wasted. In this case, in the array structure in which the rectangular unit pieces having the same size are arranged mainly in the inclination direction such that the rectangular unit pieces fully coincide with one another at one side of each rectangular unit piece, the effective width W of the base material is greater than the cutting width D, i.e., a width defined between the upper end of each uppermost row rectangular unit piece and the lower end of each lowermost row rectangular unit piece, when the rectangular unit pieces are arranged in a condition in which the number of the rectangular unit pieces is the maximum (N). At this time, in the array structure of the rectangular unit pieces according to the first invention, a cutting width d defined between the upper end of the uppermost row rectangular unit piece and the lower end of the lowermost row rectangular unit piece may be configured to satisfy Equation (1) below.

D<d≦W (1)

Consequently, the cutting width according to the first invention is greater than the cutting width in the conventional array structure of the rectangular unit pieces in which the rectangular unit pieces fully coincide with one another at one side of each rectangular unit piece. In the array structure of the rectangular unit pieces according to the first invention, therefore, it is possible to additionally arrange rectangular unit pieces in the lateral direction of the base material or to further improve the utilization of the effective width W of the base material.

In connection with the above-described array structure of the rectangular unit pieces, it is preferred for the number n of the rectangular unit pieces arranged in the inclination direction to satisfy Equation (2) below.

n≧N+1 (2)

Specifically, when the vertex coordinates (B′x, B′y) of the rightmost end are greater than the imaginary vertex coordinates (Bx, By) in the two rectangular unit pieces in contact with each other at one side of each rectangular unit piece in the inclination direction according to the definition of the first invention, the height between the uppermost end and the lowermost end of the combination of the two rectangular unit pieces decreases by the y-coordinate difference By-B′y. Consequently, when this array structure of the two rectangular unit pieces is repeatedly applied to a plurality of rectangular unit pieces, the height difference By-B′y proportionally and cumulatively increases, with the result that one or more rectangular unit pieces may be further included in the actual center connection axis direction. More preferably, the array structure of the rectangular unit pieces satisfies the following condition: n=N+1.

On the other hand, when D′x is less than Dx and D′y is greater than Dy in the two rectangular unit pieces in contact with each other at one side of each rectangular unit piece in the direction mainly perpendicular to the inclination direction according to the definition of the second invention, the height difference between the uppermost end and the lowermost end of the combination of the two rectangular unit pieces decreases, and the x-coordinate corresponding to the longitudinal direction of the base material decreases. Consequently, the array width of the combination of the two rectangular unit pieces in the longitudinal direction of the base material decreases by the x-coordinate difference Dx-D′x, thereby improving the cutting efficiency at a repetitive cutting process. This array structure of the rectangular unit pieces improves the utilization of the effective width of the base material, although the numbers of the rectangular unit pieces arranged in the lateral direction of the base material are the same, and reduces the cutting width in the longitudinal direction of the base material, thereby improving the cutting efficiency.

However, the first invention and the second invention have the same effect in maximizing the cutting width of the base material.

In the present invention, the effective width of the base material means a region of the base material where the cutting is substantially possible excluding a region included in the cut rectangular unit pieces or regions of the base material where the cutting is difficult (for example, upper end and lower end regions of the base material) due to properties of the base material or factors caused during the cutting process. According to circumstances, the effective width of the base material may be the same as the actual width of the base material.

In a preferred embodiment of maximally utilize the effective width of the base material, the width d of the base material is not less than 95% of the width W of the base material. More preferably, the width d of the base material is 100% of the width W of the base material. In this case, the uppermost row rectangular unit pieces are in contact with the upper end of the effective width of the base material, and the lowermost row rectangular unit pieces are in contact with the lower end of the effective width of the base material.

In accordance with another aspect of the present invention, there is provided a scrap obtained after cutting one or more kinds of rectangular unit pieces from a base material at a predetermined inclination.

Specifically, the present invention provides a scrap obtained after cutting one or more kinds of rectangular unit pieces from a base material at a predetermined inclination, the scrap including a plurality of bores, corresponding to the rectangular unit pieces, continuously connected to one another by a cutting margin, two of the rectangular unit piece bores being arranged mainly in the inclination direction such that the rectangular unit piece bores are in contact with each other at one side of each rectangular unit piece bore, wherein, on the assumption that imaginary vertex coordinates of a leftmost end are (Ax, Ay), and imaginary vertex coordinates of a rightmost end are (Bx, By), when the rectangular unit piece bores coincide with each other at a left or right side of each rectangular unit piece bore, vertex coordinates (B′x, B′y) of the rightmost end are greater than the imaginary vertex coordinates (Bx, By) of the rightmost end based on the imaginary vertex coordinates (Ax, Ay) of the leftmost end in an array of the rectangular unit piece bores having a higher cutting area ratio than the imaginary array of the rectangular unit piece bores.

In accordance with a further aspect of the present invention, there is provided a scrap obtained after cutting one or more kinds of rectangular unit pieces from a base material at a predetermined inclination, the scrap including a plurality of bores, corresponding to the rectangular unit pieces, continuously connected to one another by a cutting margin, two of the rectangular unit piece bores being arranged in the direction mainly perpendicular to the inclination direction such that the rectangular unit piece bores are in contact with each other at one side of each rectangular unit piece bore, wherein, on the assumption that imaginary vertex coordinates of a leftmost end are (Cx, Cy), and imaginary vertex coordinates of a rightmost end are (Dx, Dy), when the rectangular unit piece bores coincide with each other at a left or right side of each rectangular unit piece bore, vertex coordinates (D′x, D′y) of the rightmost end have D′x less than Dx and D′y greater than Dy in an array of the rectangular unit piece bores having a higher cutting area ratio than the imaginary array of the rectangular unit piece bores.

The shape of the rectangular unit piece bores of the scrap reflects the cutters of the cutter frame or the array shape of the cutters. Consequently, in the cutter frame corresponding to the scrap, the cutters are spaced apart from each other between the rectangular unit pieces by a cutting margin, and the cutters are arranged such that neighboring two rectangular unit pieces are offset from each other in the inclination direction or in the direction perpendicular to the inclination direction.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 are typical views illustrating a conventional cutter frame in which rectangular unit pieces are located on a base material to construct cutters corresponding to the rectangular unit pieces;

FIGS. 3 and 4 are views illustrating coordinate systems in which one kind of two rectangular unit pieces are in contact with each other in an inclination direction, wherein FIG. 3 illustrates a conventional array structure of the rectangular unit pieces, and FIG. 4 illustrates an array structure of the rectangular unit pieces according to a preferred embodiment of a first invention of the present invention;

FIGS. 5 and 6 are views illustrating coordinate systems in which two kinds of two rectangular unit pieces are in contact with each other in an inclination direction, wherein FIG. 5 illustrates a conventional array structure of the rectangular unit pieces, and FIG. 6 illustrates an array structure of the rectangular unit pieces according to another preferred embodiment of the first invention of the present invention;

FIGS. 7 and 8 are views illustrating coordinate systems in which one kind of two rectangular unit pieces are in contact with each other in the direction perpendicular to an inclination direction, wherein FIG. 7 illustrates a conventional array structure of the rectangular unit pieces, and FIG. 8 illustrates an array structure of the rectangular unit pieces according to a preferred embodiment of a second invention of the present invention;

FIG. 9 is a typical view illustrating an array structure in which rectangular unit pieces are arranged in an inclination direction such that the respective rectangular unit pieces fully coincide with one another at one side of each rectangular unit piece according to the conventional art and an array structure in which rectangular unit pieces are arranged in an inclination direction according to the first invention of the present invention; and

FIG. 10 is a typical view illustrating an array structure in which rectangular unit pieces are arranged in the direction perpendicular to an inclination direction such that the respective rectangular unit pieces fully coincide with one another at one side of each rectangular unit piece according to the conventional art and an array structure in which rectangular unit pieces are arranged in the direction perpendicular to an inclination direction according to the second invention of the present invention.

### DETAILED DESCRIPTION OF PREFERRED EMBODIMENTS

Now, preferred embodiments of the present invention will be described in detail with reference to the accompanying drawings. It should be noted, however, that the scope of the present invention is not limited by the illustrated embodiments.

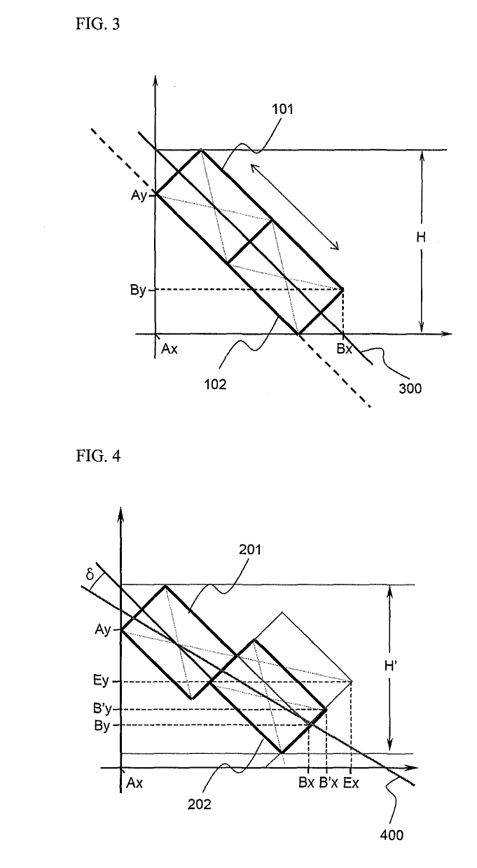

FIGS. 3 and 4 are views illustrating coordinate systems in which one kind of two rectangular unit pieces corresponding to cutters of a cutter frame are in contact with each other in an inclination direction in order to construct the cutters in the cutter frame. Specifically, FIG. 3 illustrates an array structure of the rectangular unit pieces in which the two rectangular unit pieces are arranged such that the rectangular unit pieces fully coincide with each other at one side of each rectangular unit piece according to the conventional art, and FIG. 4 illustrates an array structure of the rectangular unit pieces in which the coordinates of a rightmost end vertex of the rectangular unit piece combination are shifted according to a preferred embodiment of a first invention of the present invention. For reference, the x-coordinate of the coordinate system indicates the longitudinal direction of a base material, and the y-coordinate of the coordinate system indicates the longitudinal direction of a base material, which will be equally applied to the following drawings.

Referring first to FIG. 3, the two rectangular unit pieces 101 and 102, having the same size, are arranged at an inclination of approximately 45 degrees such that the rectangular unit pieces coincide with each other at the left side of each rectangular unit piece. Consequently, the two rectangular unit pieces 101 and 102 are in contact with each other mainly in the inclination direction such that the rectangular unit pieces fully coincide with each other at one side of each rectangular unit piece. The coordinates of a left upper end vertex of the first rectangular unit piece 101 corresponding to a leftmost end vertex of the rectangular unit piece combination are (Ax, Ay), and the coordinates of a right lower end vertex of the second rectangular unit piece 102 corresponding to a rightmost end vertex of the rectangular unit piece combination are (Bx, By). At this time, the combination of the two rectangular unit pieces 101 and 102 has a height H corresponding to the coordinates of a right upper end vertex of the first rectangular unit piece 101.

Referring to FIG. 4, on the other hand, the coordinates (Ax, Ay) of a left upper end vertex of the combination of the two rectangular unit pieces 201 and 202 are the same as those of FIG. 3, but the coordinates (B′x, B′y), i.e., the x-coordinate and the y-coordinate, of a rightmost end vertex of the combination of the two rectangular unit pieces 201 and 202 are greater than those of FIG. 3. That is, the second rectangular unit piece 202 is shifted in the right upper end direction as compared with the second rectangular unit piece 102 of FIG. 3, with the result that the rectangular unit pieces are arranged in partial contact with each other such that one side of one rectangular unit piece does not completely coincide with, but is somewhat offset from, the corresponding side of the other rectangular unit piece in the inclination direction. At this time, the combination of the two rectangular unit pieces 201 and 202 has a height H′ less than the height H of the combination of the two rectangular unit pieces 101 and 102 shown in FIG. 3. As a result, a base material has a residue width corresponding to the height difference H-H′, and the residue width of the base material proportionally and cumulatively increases when a plurality of rectangular unit pieces are repeatedly arranged. Consequently, when the coordinates are established to further form a residue width corresponding to the height of one rectangular unit piece considering an effective width of the base material, it is possible to sufficiently utilize the effective width of the base material, thereby minimizing the cutting loss.

In FIG. 4, however, when the coordinates (B′x, B′y) of the rightmost end vertex of the combination of the two rectangular unit pieces 201 and 202 are the same as the coordinates (Ex, Ey) on an extension line of the diagonal axis of the first rectangular unit piece 201, the first rectangular unit piece 201 is not in contact with the second rectangular unit piece 202. For this reason, it is preferred for the coordinates (B′x, B′y) to have a range not including at least the coordinates (Ex, Ey). That is, the x-coordinate has a range of Bx<B′x<Ex, and the y-coordinate has a range of By<B′y<Ey.

Meanwhile, in FIG. 3, an imaginary center connection axis 300, which is an axis to interconnect central points of the two rectangular unit pieces 101 and 102, is parallel to the inclination axis. On the other hand, in FIG. 4 according to the present invention, an actual center connection axis 400, which is an axis to interconnect central points of the two rectangular unit pieces 201 and 202, has a predetermined angle deviation δ from the imaginary center connection axis 300. In consideration of the utilization of the base material in the lateral direction thereof, the angle deviation δ preferably has the following range: 0<δ<20.

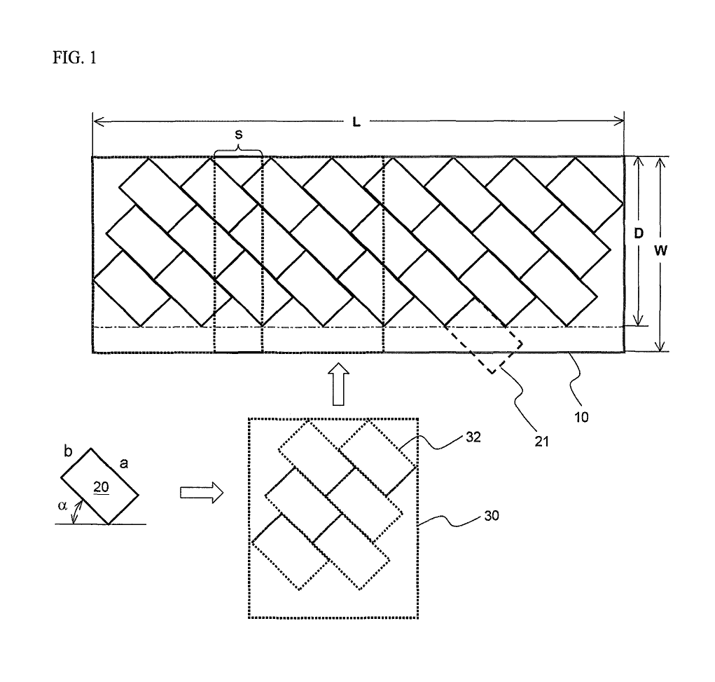

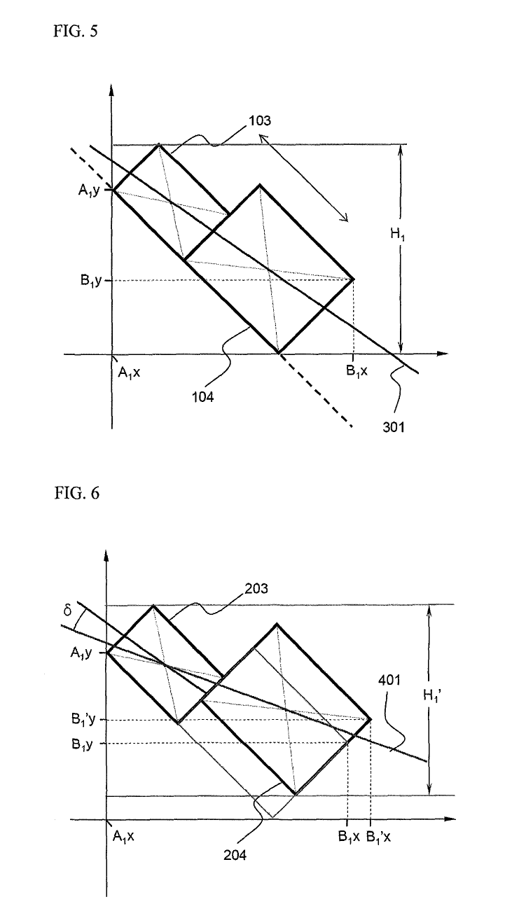

FIGS. 5 and 6 are views illustrating coordinate systems in which two kinds of two rectangular unit pieces corresponding to cutters of a cutter frame are in contact with each other in an inclination direction in order to construct the cutters in the cutter frame. Specifically, FIG. 5 illustrates an array structure of the rectangular unit pieces in which the two rectangular unit pieces are arranged such that the rectangular unit pieces fully coincide with each other at the left side of each rectangular unit piece according to the conventional art, and FIG. 6 illustrates an array structure of the rectangular unit pieces in which the coordinates of a rightmost end vertex of the rectangular unit piece combination are shifted according to another preferred embodiment of the first invention of the present invention. FIG. 5 illustrates the array of some rectangular unit pieces in the array structure of the rectangular unit pieces shown in FIG. 1.

Referring first to FIG. 5, the first rectangular unit piece 103, having a relatively small size, and the second rectangular unit piece 104, having a relatively large size, are arranged at an inclination of approximately 45 degrees (indicated by a red-colored arrow) such that the rectangular unit pieces coincide with each other at the left side of each rectangular unit piece. The coordinates of a left upper end vertex of the first rectangular unit piece 103 corresponding to a leftmost end vertex of the rectangular unit piece combination are (A₁x, A₁y), and the coordinates of a right lower end vertex of the second rectangular unit piece 104 corresponding to a rightmost end vertex of the rectangular unit piece combination are (B₁x, B₁y).

Referring to FIG. 6, on the other hand, the coordinates (A₁x, A₁y) of a left upper end vertex of the combination of the two rectangular unit pieces 203 and 204 are the same as those of FIG. 5, but the coordinates (B₁′x, B₁′y), i.e., the x-coordinate and the y-coordinate, of a rightmost end vertex of the combination of the two rectangular unit pieces 203 and 204 are greater than those of FIG. 5. That is, the second rectangular unit piece 204 is shifted in the right upper end direction as compared with the second rectangular unit piece 104 of FIG. 5, with the result that the rectangular unit pieces 203 and 204 are arranged such that one side of one rectangular unit piece is somewhat offset from the corresponding side of the other rectangular unit piece. Also, a predetermined angle deviation is defined between an imaginary center connection axis 301 of FIG. 5 and an actual center connection axis 401 of FIG. 6.

Here, the combination of the two rectangular unit pieces 203 and 204 has a height H₁′ less than the height H₁ of the combination of the two rectangular unit pieces 101 and 102 shown in FIG. 5. As a result, a base material has a residue width corresponding to the height difference H₁-H₁′. As described above, even when two kinds of the rectangular unit pieces are used, it is possible to reduce the height difference H-H′ in the same manner as in FIGS. 3 and 4 in which one kind of the rectangular unit pieces are used by shifting the rightmost end vertex of the rectangular unit piece combination, thereby sufficiently utilizing the effective width of the base material. Simultaneous cutting of two or more kinds of the rectangular unit pieces is preferably used to actively manufacture various kinds of the rectangular unit pieces according to the fluctuation of demand.

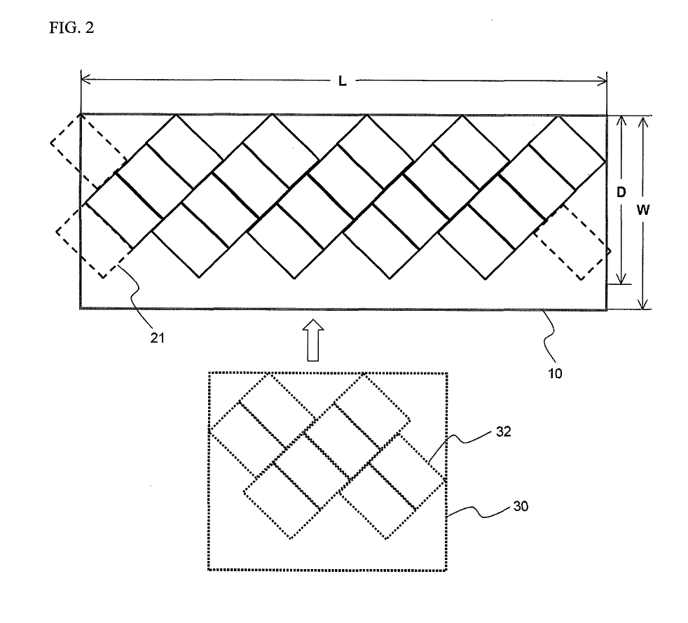

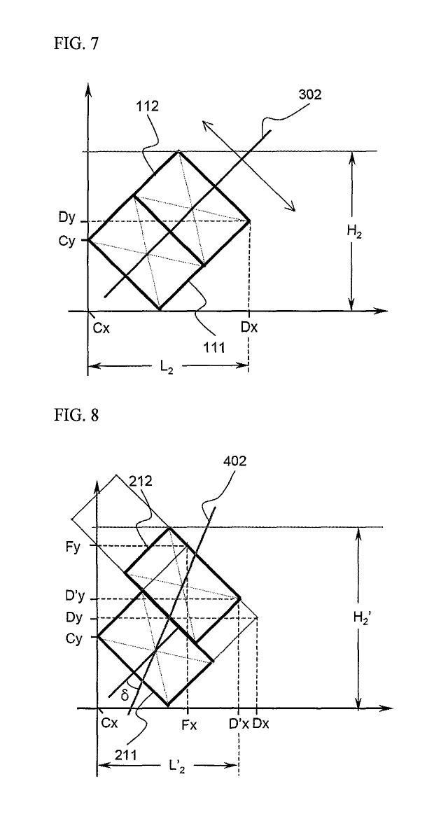

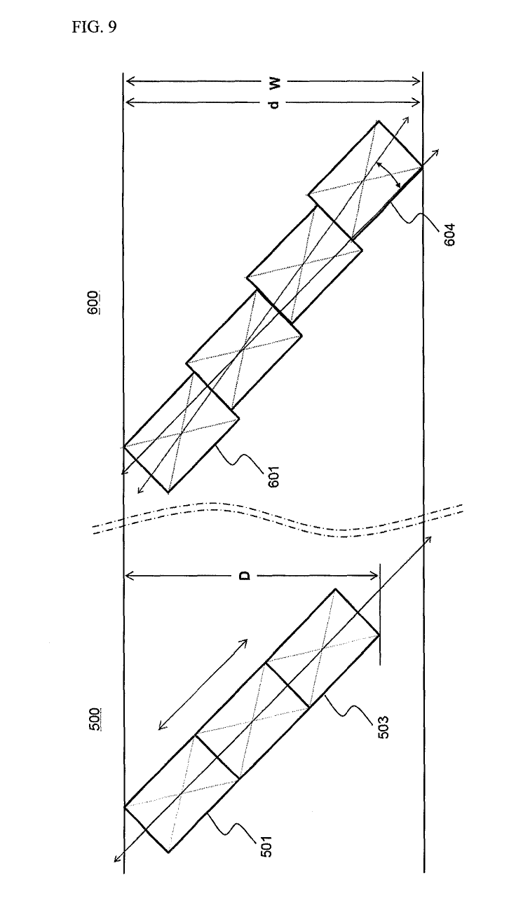

FIGS. 7 and 8 are views illustrating coordinate systems in which one kind of two rectangular unit pieces corresponding to cutters of a cutter frame are in contact with each other in the direction perpendicular to an inclination direction (indicated by a red-colored arrow) in order to construct the cutters in the cutter frame. Specifically, FIG. 7 illustrates an array structure of the rectangular unit pieces in which the two rectangular unit pieces are arranged such that the rectangular unit pieces fully coincide with each other at one side of each rectangular unit piece according to the conventional art, and FIG. 8 illustrates an array structure of the rectangular unit pieces in which the coordinates of a rightmost end vertex of the rectangular unit piece combination are shifted according to another preferred embodiment of the present invention. FIG. 7 illustrates the array of some rectangular unit pieces in the array structure of the rectangular unit pieces shown in FIG. 2.

Referring first to FIG. 7 according to the conventional art, the two rectangular unit pieces 111 and 112 are in contact with each other in the direction perpendicular to the inclination direction such that the rectangular unit pieces fully coincide with each other at the long side of each rectangular unit piece. At this time, the coordinates of a left upper end vertex of the first rectangular unit piece 111 corresponding to a leftmost end vertex of the rectangular unit piece combination are (Cx, Cy), and the coordinates of a right lower end vertex of the second rectangular unit piece 112 corresponding to a rightmost end vertex of the rectangular unit piece combination are (Dx, Dy). Also, an imaginary center connection axis 302, which is an axis to interconnect central points of the first and second rectangular unit pieces 111 and 112, is perpendicular to the inclination axis. In addition, the combination of the two rectangular unit pieces 111 and 112 has a height H₂ and a width L₂ in the longitudinal direction of the base material.

Referring to FIG. 8, on the other hand, the coordinates (Cx, Cy) of a left upper end vertex of the combination of the two rectangular unit pieces 211 and 212 according to the present invention are the same as those of FIG. 7, but the coordinates (D′x, D′y) of a rightmost end vertex of the combination of the two rectangular unit pieces 211 and 212 are different from the coordinates (Dx, Dy) of the rightmost end vertex of FIG. 7. Specifically, the x-coordinate decreases, whereas the y-coordinate increases, as compared with FIG. 7. That is, the second rectangular unit piece 212 is shifted in the left upper end direction as compared with the second rectangular unit piece 112 of FIG. 7, with the result that the rectangular unit pieces are arranged in partial contact with each other such that the long side of one rectangular unit piece does not completely coincide with, but is somewhat offset from, the corresponding long side of the other rectangular unit piece in the direction perpendicular to the inclination direction. Also, a predetermined angle deviation δ is defined between an actual center connection axis 402 to interconnect central points of the two rectangular unit pieces 211 and 212 and an imaginary center connection axis 302 of FIG. 7.

Here, the combination of the two rectangular unit pieces 211 and 212 has a height H₂′ greater than the height H₂ of the combination of the rectangular unit pieces 111 and 112 shown in FIG. 7. On the other hand, the combination of the two rectangular unit pieces 211 and 212 has a width L₂′ less than the width L₂ of the combination of the rectangular unit pieces 111 and 112 shown in FIG. 7.

Referring to FIGS. 2 and 8 together, therefore, it is possible to maximally utilize the effective width of the base material by the increased height H₂, and, in addition, it is possible to achieve greater cutting efficiency as compared with the array structure of the rectangular unit pieces as shown in FIG. 7 by the decreased width L₂′ in the longitudinal direction of the base material.

In FIG. 8, however, when the coordinates (D′x, D′y) of the rightmost end vertex of the combination of the two rectangular unit pieces 211 and 212 are the same as the coordinates (Fx, Fy) of a right lower end vertex of the second rectangular unit piece 212 when the coordinates of a right upper end vertex of the second rectangular unit piece 212 have coordinate values on an extension line of the diagonal axis of the first rectangular unit piece 211, the first rectangular unit piece 211 is not in contact with the second rectangular unit piece 212. For this reason, it is preferred for the coordinates (D′x, D′y) to have a range not including at least the coordinates (Fx, Fy). That is, the x-coordinate has a range of Dx<D′x<Fx, and the y-coordinate has a range of Dy<D′y<Fy.

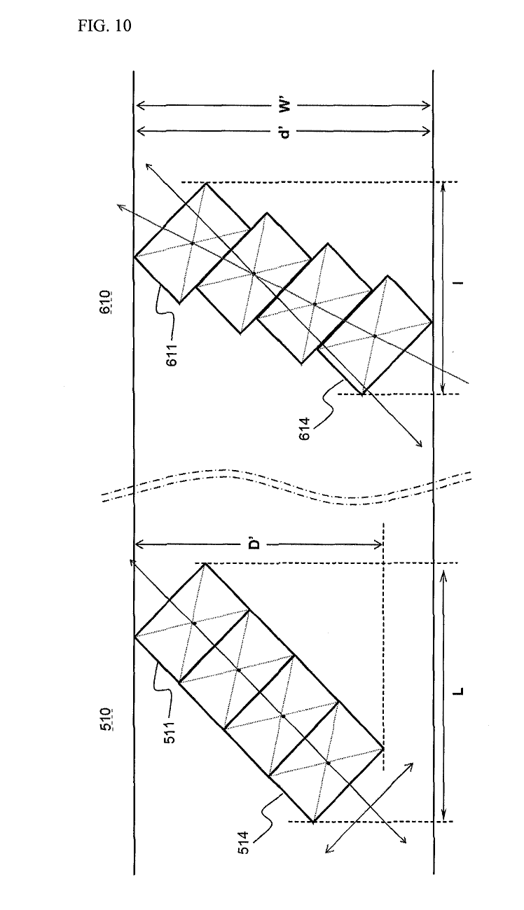

FIG. 9 is a typical view illustrating an array structure in which rectangular unit pieces are arranged in an inclination direction such that the respective rectangular unit pieces fully coincide with one another at one side of each rectangular unit piece according to the conventional art and an array structure in which rectangular unit pieces are arranged in an inclination direction according to the first invention of the present invention. The reference numeral of a base material is omitted for convenience of description. Also, although not shown in the drawing, a cutting margin may be provided between the respective rectangular unit pieces such that the respective rectangular unit pieces can be cut as independent rectangular unit pieces by the cutters of the cutter frame.

Referring to FIG. 9, when the rectangular unit pieces are arranged in the inclination direction according to the conventional art (500), the cutting width D, which is a width between the upper end of the uppermost row rectangular unit piece 501 and the lower end of the lowermost row rectangular unit piece 503, is remarkably less than the effective width W of the base material, and the maximum number of the rectangular unit pieces arranged in the inclination direction is three.

On the other hand, when the rectangular unit pieces are arranged such that rectangular unit pieces are somewhat offset from one another according to the present invention, the cutting width d, which is a width between the upper end of the uppermost row rectangular unit piece 601 and the lower end of the lowermost row rectangular unit piece 604, is almost equal to the effective width W of the base material, and the maximum number of the rectangular unit pieces arranged in the inclination direction is four. Consequently, when the coordinates of the rightmost end of the rectangular unit piece combination are shifted to arrange the rectangular unit pieces according to the present invention, it is possible to increase the number of the rectangular unit pieces arranged with the maximum length while maximally utilizing the effective width W of the base material, thereby improving the cutting efficiency.

FIG. 10 is a typical view illustrating an array structure in which rectangular unit pieces are arranged mainly in the direction perpendicular to an inclination direction such that the respective rectangular unit pieces fully coincide with one another at one side of each rectangular unit piece according to the conventional art and an array structure in which rectangular unit pieces are arranged mainly in the direction perpendicular to an inclination direction according to the second invention of the present invention.

Referring to FIG. 10, when the rectangular unit pieces are arranged according to the conventional art (510), the cutting width D′, which is a width between the upper end of the uppermost row rectangular unit piece 511 and the lower end of the lowermost row rectangular unit piece 514, is remarkably less than the effective width W′ of a base material, and the number of the rectangular unit pieces arranged such that the rectangular unit pieces are in contact with one another with the maximum length in the inclination direction is four. On the other hand, when the x-coordinate of the coordinates of a rightmost end vertex of the rectangular unit piece combination is decreased, and the y-coordinate of the coordinates of the rightmost end vertex of the rectangular unit piece combination is increased, such that the rectangular unit pieces are somewhat offset from one another, according to the present invention, the cutting width d′, which is a width between the upper end of the uppermost row rectangular unit piece 611 and the lower end of the lowermost row rectangular unit piece 614, is almost equal to the effective width W′ of the base material, and the number of the rectangular unit pieces arranged such that the rectangular unit pieces are in contact with one another with the maximum length in the inclination direction is four, which is the same as the conventional art. According to the present invention, therefore, it is possible to remarkably reduce the width 1 of the rectangular unit piece combination in the longitudinal direction of the base material as compared with the width L of the conventional rectangular unit piece combination, thereby improving the cutting efficiency at a repetitive cutting process.

### INDUSTRIAL APPLICABILITY

As apparent from the above description, the cutter frame according to the present invention exhibits high cutting efficiency through a unique and regular array structure of rectangular unit pieces when the rectangular unit pieces, of which the direction particularity is required according to the properties of a material, are to be cut from a base material while the rectangular unit pieces are inclined to the base material. In particular, when a large amount of rectangular unit pieces are produced through mass production, it is possible to greatly reduce the total manufacturing costs of the rectangular unit pieces based on the high cutting efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cutter frame including a plurality of cutters for cutting one or more kinds of rectangular unit pieces having a relatively small size from a rectangular base material at a predetermined inclination, the cutters being mounted or formed in the cutter frame such that the cutters correspond to the rectangular unit pieces, two of the rectangular unit pieces being arranged mainly in the inclination direction such that the rectangular unit pieces are in contact with each other at one side of each rectangular unit piece, wherein
on the assumption that imaginary vertex coordinates of a leftmost end are (Ax, Ay), and imaginary vertex coordinates of a rightmost end are (Bx, By), when the rectangular unit pieces coincide with each other at a left or right side of each rectangular unit piece,
vertex coordinates (B′x, B′y) of the rightmost end are greater than the imaginary vertex coordinates (Bx, By) of the rightmost end based on the imaginary vertex coordinates (Ax, Ay) of the leftmost end in an array having a higher cutting area ratio than the imaginary array.

2. A cutter frame including a plurality of cutters for cutting one or more kinds of rectangular unit pieces having a relatively small size from a rectangular base material at a predetermined inclination, the cutters being mounted or formed in the cutter frame such that the cutters correspond to the rectangular unit pieces, two of the rectangular unit pieces being arranged in the direction mainly perpendicular to the inclination direction such that the rectangular unit pieces are in contact with each other at one side of each rectangular unit piece, wherein
on the assumption that imaginary vertex coordinates of a leftmost end are (Cx, Cy), and imaginary vertex coordinates of a rightmost end are (Dx, Dy), when the rectangular unit pieces coincide with each other at a left or right side of each rectangular unit piece, vertex coordinates (D′x, D′y) of the rightmost end have D′x less than Dx and D′y greater than Dy in an array having a higher cutting area ratio than the imaginary array.

3. The cutter frame according to claim 1, wherein the cutters are arranged such that an axis (‘actual center connection axis’) to interconnect central points of the two rectangular unit pieces has an angle deviation (δ) of 0<δ<90 from an axis (‘imaginary center connection axis’) to interconnect central points of the two rectangular unit pieces when one of the two rectangular unit pieces, arranged in the inclination direction such that the rectangular unit pieces are in contact with each other at one side of each rectangular unit piece, coincides with the other rectangular unit piece at a left or right side of each rectangular unit piece.

4. The cutter frame according to claim 1, wherein, when the two rectangular unit pieces have the same size, the imaginary center connection axis is parallel or perpendicular to the inclination axis.

5. The cutter frame according to claim 1, wherein, when the rectangular unit pieces have a cutting inclination angle of A, the angle deviation (δ) satisfies a condition of 0<δ<A.

6. The cutter frame according to claim 1, wherein the cutting inclination angle is 45 degrees.

7. The cutter frame according to claim 1, wherein the angle deviation (δ) has a range of 0<δ<20.

8. The cutter frame according to claim 1, wherein the base material is a continuous material having a predetermined width and a relatively very long length.

9. The cutter frame according to claim 1, wherein each of the cutters is a knife for cutting or a light source for cutting.

10. The cutter frame according to claim 9, wherein the knife for cutting is a metal knife or a jet water knife, and the light source for cutting is laser.

11. The cutter frame according to claim 1, wherein, when the rectangular unit pieces having the same size are arranged in the inclination direction, such that the number of the rectangular unit pieces is the maximum (N), in a condition in which the rectangular unit pieces coincide with one another at a long or short side of each rectangular unit piece, the base material has an effective width (W) greater than a cutting width (D) defined between an upper end of each uppermost row rectangular unit piece and a lower end of each lowermost row rectangular unit piece, and the cutters are arranged in a structure that satisfies the following conditions to achieve a maximum cutting area ratio:
(a) A cutting width (d) defined between the upper end of the uppermost row rectangular unit piece and the lower end of the lowermost row rectangular unit piece satisfies Equation (1) below.
D<d<W (1)
(b) When the rectangular unit pieces are in contact with one another at one side of each rectangular unit piece in the inclination direction, the maximum number (n) of the rectangular unit pieces arranged in the inclination direction satisfies Equation (2) below
n>N+1 (2).

12. The cutter frame according to claim 11, wherein the following condition is satisfied: n=N+1.

13. The cutter frame according to claim 1, wherein uppermost row rectangular unit pieces are in contact with an upper end of an effective width of the base material, and lowermost row rectangular unit pieces are in contact with a lower end of the effective width of the base material.

14. A scrap obtained after cutting one or more kinds of rectangular unit pieces from a base material at a predetermined inclination, the scrap including a plurality of bores, corresponding to the rectangular unit pieces, continuously connected to one another by a cutting margin, two of the rectangular unit piece bores being arranged mainly in the inclination direction such that the rectangular unit piece bores are in contact with each other at one side of each rectangular unit piece bore, wherein
on the assumption that imaginary vertex coordinates of a leftmost end are (Ax, Ay), and imaginary vertex coordinates of a rightmost end are (Bx, By), when the rectangular unit piece bores coincide with each other at a left or right side of each rectangular unit piece bore, vertex coordinates (B′x, B′y) of the rightmost end are greater than the imaginary vertex coordinates (Bx, By) of the rightmost end based on the imaginary vertex coordinates (Ax, Ay) of the leftmost end in an array of the rectangular unit piece bores having a higher cutting area ratio than the imaginary array of the rectangular unit piece bores.

15. A scrap obtained after cutting one or more kinds of rectangular unit pieces from a base material at a predetermined inclination, the scrap including a plurality of bores, corresponding to the rectangular unit pieces, continuously connected to one another by a cutting margin, two of the rectangular unit piece bores being arranged in the direction mainly perpendicular to the inclination direction such that the rectangular unit piece bores are in contact with each other at one side of each rectangular unit piece bore, wherein
on the assumption that imaginary vertex coordinates of a leftmost end are (Cx, Cy), and imaginary vertex coordinates of a rightmost end are (Dx, Dy), when the rectangular unit piece bores coincide with each other at a left or right side of each rectangular unit piece bore,
vertex coordinates (D′x, D′y) of the rightmost end have D′x less than Dx and D′y greater than Dy in an array of the rectangular unit piece bores having a higher cutting area ratio than the imaginary array of the rectangular unit piece bores.

16. The cutter frame according to claim 2, wherein the cutters are arranged such that an axis (‘actual center connection axis’) to interconnect central points of the two rectangular unit pieces has an angle deviation (δ) of 0<δ<90 from an axis (‘imaginary center connection axis’) to interconnect central points of the two rectangular unit pieces when one of the two rectangular unit pieces, arranged in the inclination direction such that the rectangular unit pieces are in contact with each other at one side of each rectangular unit piece, coincides with the other rectangular unit piece at a left or right side of each rectangular unit piece.

17. The cutter frame according to claim 2, wherein, when the two rectangular unit pieces have the same size, the imaginary center connection axis is parallel or perpendicular to the inclination axis.

18. The cutter frame according to claim 2, wherein, when the rectangular unit pieces have a cutting inclination angle of A, the angle deviation (δ) satisfies a condition of 0<δ<A.

19. The cutter frame according to claim 2, wherein the cutting inclination angle is 45 degrees.

20. The cutter frame according to claim 2, wherein the angle deviation (δ) has a range of 0<δ<20.

21. The cutter frame according to claim 2, wherein the base material is a continuous material having a predetermined width and a relatively very long length.

22. The cutter frame according to claim 2, wherein each of the cutters is a knife for cutting or a light source for cutting.

23. The cutter frame according to claim 22, wherein the knife for cutting is a metal knife or a jet water knife, and the light source for cutting is laser.

24. The cutter frame according to claim 2, wherein uppermost row rectangular unit pieces are in contact with an upper end of an effective width of the base material, and lowermost row rectangular unit pieces are in contact with a lower end of the effective width of the base material.
